(19) United States
(12) Patent Application Publication
(10) Pub. No.: US 2014/0157412 A1
(43) Pub. Date: Jun. 5, 2014

(54) DEVICE, METHOD AND NON-TRANSITORY COMPUTER READABLE STORAGE MEDIUM THEREOF FOR PERFORMING ANONYMOUS TESTING ON ELECTRONIC DIGITAL

(71) Applicant: INSTITUTE FOR INFORMATION INDUSTRY, Taipei (TW)

(72) Inventors: Zhi-Wei CHEN, Taipei City (TW); Chia-Wei TIEN, Taichung City (TW); Chin-Wei TIEN, New Taipei City (TW); Chih-Hung LIN, New Taipei City (TW)

(73) Assignee: INSTITUTE FOR INFORMATION INDUSTRY, TAIPEI (TW)

(21) Appl. No.: 13/775,104

(22) Filed: Feb. 22, 2013

(30) Foreign Application Priority Data
Dec. 3, 2012 (TW) 101145317

(51) Int. Cl. G06F 21/64

(52) U.S. Cl. CPC G06F 21/64
USPC 726/23

(57) ABSTRACT

A method for performing anonymous testing on electronic digital data is provided. The method comprises the steps outlined below. At least one electronic digital data is received. A type of the electronic digital data is identified to retrieve a plurality of data fields according to the type of the electronic digital data, in which the data fields further comprises a plurality of data blocks. The data fields and the data blocks are analyzed such that they are categorized as at least one logic operation part and at least one data content part. A data-hiding process is performed on the data content part only to generate output electronic digital data and a subsequent analysis is performed on the output electronic digital data.

### RELATED APPLICATION

This application claims priority to Taiwan Application Serial Number 101145317, filed Dec. 3, 2012, which is herein incorporated by reference.

### BACKGROUND

1. Technical Field

The present disclosure relates to an anonymous testing technology. More particularly, the present disclosure relates to a device, a method and a non-transitory computer readable storage medium thereof for performing anonymous testing on electronic digital data.

2. Description of Related Art

The computer systems and networks are used in various enterprises and organizations to manage and transmit electronic digital data. However, security vulnerabilities always exist in the computer systems and networks. The information security is thus threatened by the hackers and the virus. In order to protect the electronic digital data from the attack of the malicious software and virus, it is necessary to perform scanning and detecting processes on the electronic digital data of the enterprises and the organizations.

There are more and more virus or malicious software designed to attack the document-type and the image-type electronic digital data that may include important information of the enterprises or organizations. However, the risk of leaking of the confidential contents is high when the vulnerability scanning process is performed by an external cloud system that is not part of the enterprises or organizations. However, if the data-hiding process is performed on the whole electronic digital data, both the original content of the file and the malicious features are hidden such that the vulnerability scanning process is not able to detect the malicious features.

Accordingly, what is needed is a device, a method and a non-transitory computer readable storage medium thereof for performing anonymous testing on electronic digital data to allow the performance of the external analysis without leaking the confidential contents.

### SUMMARY

An aspect of the present invention is to provide a method for performing anonymous testing on electronic digital data. The method comprises the steps outlined below. At least one electronic digital data is received. A type of the electronic digital data is identified to retrieve a plurality of data fields according to the type of the electronic digital data, in which the data fields further comprises a plurality of data blocks. The data fields and the data blocks are analyzed such that they are categorized as at least one logic operation part and at least one data content part. A data-hiding process is performed on the data content part only to generate output electronic digital data and a subsequent analysis is performed on the output electronic digital data.

Another aspect of the present invention is to provide a device for performing anonymous testing on electronic digital data. The device comprises a receiving module, a type identification module, a field-analyzing module and a data-hiding module. The receiving module receives at least one electronic digital data. The type identification module identifies a type of the electronic digital data to retrieve a plurality of data fields according to the type of the electronic digital data, in which the data fields further comprises a plurality of data blocks. The field-analyzing module analyzes the data fields and the data blocks such that the data fields and the data blocks are categorized as at least one logic operation part and at least one data content part. The data-hiding module performs a data-hiding process on the data content part only to generate at least one output electronic digital data such that and performing a subsequent analysis on the output electronic digital data.

Yet another aspect of the present invention is to provide a non-transitory computer readable storage medium to store a computer program to execute method for performing anonymous testing on electronic digital data. The method comprises the steps outlined below. At least one electronic digital data is received. A type of the electronic digital data is identified to retrieve a plurality of data fields according to the type of the electronic digital data, in which the data fields further comprises a plurality of data blocks. The data fields and the data blocks are analyzed such that they are categorized as at least one logic operation part and at least one data content part. A data-hiding process is performed on the data content part only to generate output electronic digital data and a subsequent analysis is performed on the output electronic digital data.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a device for performing anonymous testing on electronic digital data in an embodiment of the present invention;

FIG. 2 is a diagram of a document-type electronic digital data and its data fields in an embodiment of the present invention;

FIG. 3 is a diagram of an image-type electronic digital data and its data fields in an embodiment of the present invention; and

FIG. 4 is a flow chart of a method for performing anonymous testing on electronic digital data in an embodiment of the present invention.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

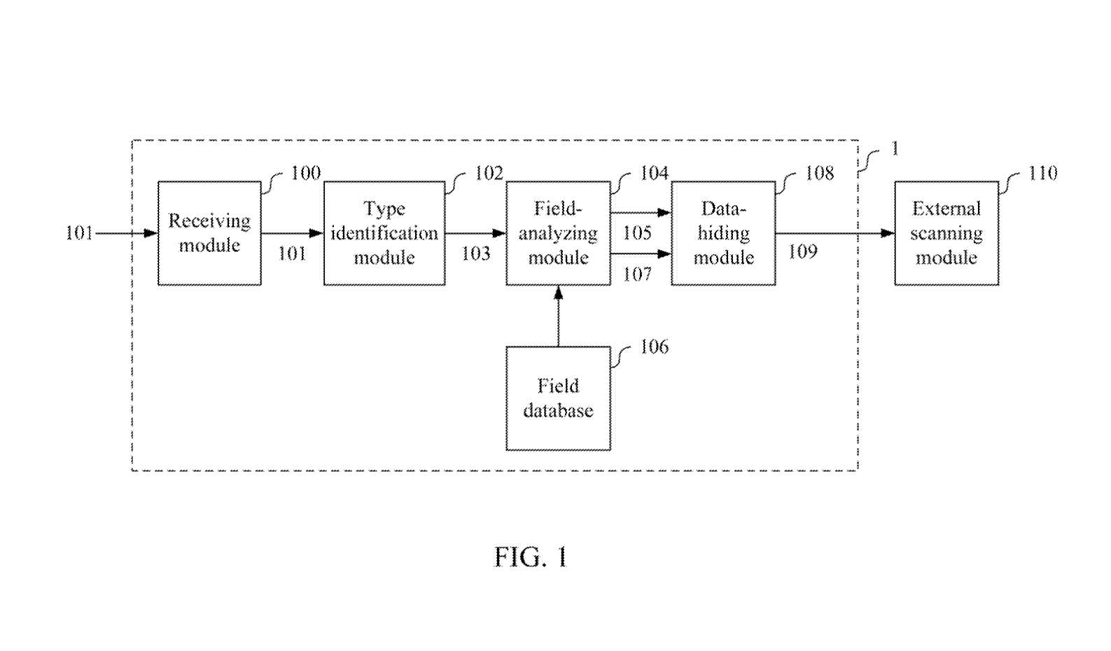

FIG. 1 is a device 1 for performing anonymous testing on electronic digital data in an embodiment of the present invention. The device 1 comprises a receiving module 100, a type identification module 102, a field-analyzing module 104, a field database 106 and a data-hiding module 108.

The receiving module 100 receives at least one electronic digital data 101. The type identification module 102 identifies a type of the electronic digital data 101. In different embodiments, the electronic digital data 101 can be different types of files, data streams or network packets. For example, the electronic digital data 101 can be, but not limited to, a document, an image or a system execution file, etc.

After identifying the type of the electronic digital data 101, the type identification module 102 further retrieves a plurality of data fields 103 according to the type of the electronic digital data 101. In the present embodiment, since the document and the image have greater chances to include the contents of user information or related important information, the type identification module 102 mainly deals with the electronic digital data 101 that belongs to the type of document and image. Therefore, the data fields 103 of the document-type and the image-type electronic digital data can be retrieved.

The document-type electronic digital data 101 may be, but not limited, the document files of Microsoft Word, Excel and Powerpoint, etc. The image-type electronic digital data 101 may be in the formats of, but not limited to, JPEG, GIF, BMP and TIFF. In other embodiments, the type identification module 102 can also retrieve the data fields of other types of electronic digital data 101 having important information after identifying them. In the present embodiment, each of the data fields 103 comprises a plurality of data blocks.

The field-analyzing module 104 analyzes the data fields 103 and the data blocks such that the data fields 103 and the data blocks are categorized as at least one logic operation part 105 and at least one data content part 107. In both the document-type and the image-type electronic digital data 101, parts of the data fields are the logic operation parts used to define such as, but not limited to, the size, the layout or the fonts of the electronic digital data. The data fields that comprise the document contents can be further categorized as a plurality of data blocks. Parts of the data blocks are also the logic operation parts used to define the beginning, the end and the layout of the document. Hence, the contents of the document can be displayed according to the setting of the logic operation part when the electronic digital data 101 is opened.

In the present embodiment, the field-analyzing module 104 analyzes the data fields 103 and the data blocks by acquiring the information stored in the to field database 106. For example, the field database 106 can stored the features of the data fields and the data blocks of various kinds of electronic digital data in advance. After acquiring the field database 106 according to the identified data type and the retrieved data fields 103, the field-analyzing module 104 can analyze the data fields 103 to determine the logic operation part 105 and the data content part 107.

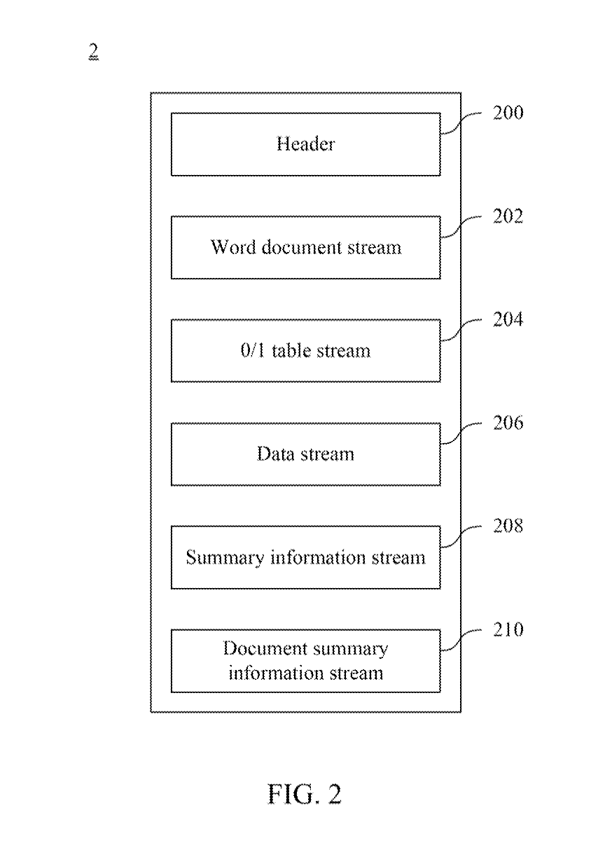

FIG. 2 is a diagram of a document-type electronic digital data 2 and its data fields in an embodiment of the present invention. In the present embodiment, a Word document file is used as an example of the document-type electronic digital data 2.

The data fields of the document-type electronic digital data 2 comprises a header 200, a word document stream 202, a 0/1 table data stream 204, a data stream 206, a summary information stream 208 and a document summary information stream 210. The header 200 is the header information of the document-type electronic digital data 2. The word document stream 202 stores the actual context of the document. The 0/1 table data stream 204 stores the data structure setting of the document-type electronic digital data 2. The data stream 206 stores the object or picture embedded in the document-type electronic digital data 2. The summary information stream 208 stores the user related summary information. The document summary information stream 210 stores the file-related summary information.

Therefore, after acquiring the field database 106, the field-analyzing module 104 can distinguish the header 200, the 0/1 table data stream 204, the summary information stream 208 and the document summary information stream 210 as the logic operation parts. The data blocks in the word document stream 202 and the data stream 206 need to be further analyzed by the field-analyzing module 104 to determine the logic operation part and the data content part in the stream.

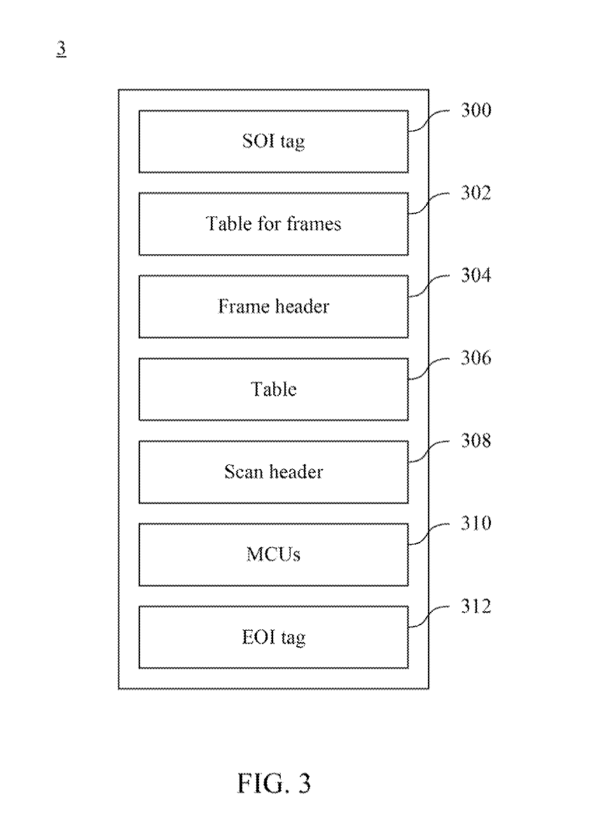

FIG. 3 is a diagram of an image-type electronic digital data 3 and its data fields in an embodiment of the present invention. In the present embodiment, a JPEG document file is used as an example of the image-type electronic digital data 3.

The data fields of the image-type electronic digital data 3 comprises a start-of-image (SOI) tag 300, a table 302 for frames, a frame header 304, a table 306, a scan header 308, minimum coded units (MCUs) 310 and an end-of-frame (EOI) tag 312. The SOI tag 300 labels the beginning position of the image. The table 302, the frame header 304, the table 306 and the scan header 308 store the header information of the image-type electronic digital data 3. The MCUs 310 store the encoded content of the image-type electronic digital data 3. The EOI tag 312 labels the end position of the image.

Therefore, after acquiring the field database 106, the field-analyzing module 104 can distinguish the SOI tag 300, the table 302, the frame header 304, the table 306, the scan header 308 and the EOI tag 312 as the logic operation parts. The MCUs 310 is determined to be the data content part in the image-type electronic digital data 3.

After the analysis, the data-hiding module 108 performs a data-hiding process on the data content part 107 only. In different embodiments, the data-hiding process can be an encryption process, a noise addition process, a data masking process, a random sequence generation process or a removing process. The encryption process, the noise addition process, the data masking process and the random sequence generation process can hide the content of the data such that the original content of the data is not able to be displayed properly. On the other hand, the removing process simply removes the data content part 107 from the electronic digital data 101. After the data-hiding process, at least one output electronic digital data 109 is generated such that a subsequent analysis can be performed on the output electronic digital data.

In the present embodiment, the data-hiding module 108 transmits the output electronic digital data 109 to an external scanning module 110 to perform a vulnerability scanning process on the output electronic digital data 109. The vulnerability scanning process can detect the malicious features such as virus or Trojan program. Therefore, whether the file in secure or not can be determined.

There are more and more virus or malicious software designed to attack the document-type and the image-type electronic digital data that may include important information of the enterprises or organizations. However, the risk of leaking of the confidential contents is high when the vulnerability scanning process is performed by an external cloud system that is not part of the enterprises or organizations. However, if the data-hiding process is performed on the whole electronic digital data, both the original content of the file and the malicious features are hidden such that the vulnerability scanning process is not able to detect the features.

The virus or malicious software such as the macro virus mainly attacks the logic operation part instead of the data content part. Consequently, the device 1 for performing anonymous testing on electronic digital data of the present invention can determine the type of the electronic digital data and analyze the data fields accordingly such that the confidential data contents are selected to be hidden. Therefore, the vulnerability scanning process can be performed on the electronic digital data without breaking or hiding the malicious features. It is noted that in other embodiments, the subsequent analysis performed on the output electronic digital data can be other kinds of analysis and is not limited to the vulnerability scanning process.

In different embodiments, the device 1 can be disposed in a computer host to filter the electronic digital data delivered by the computer host or can be disposed in a gateway to filter the packets passing through the gateway in a specific area of the network.

The advantage of the device for performing anonymous testing on electronic digital data of the present invention can hide the important contents of the electronic digital data. The logic operation part of the electronic digital data that is easy to be attacked can be analyzed and processed without leaking the confidential contents.

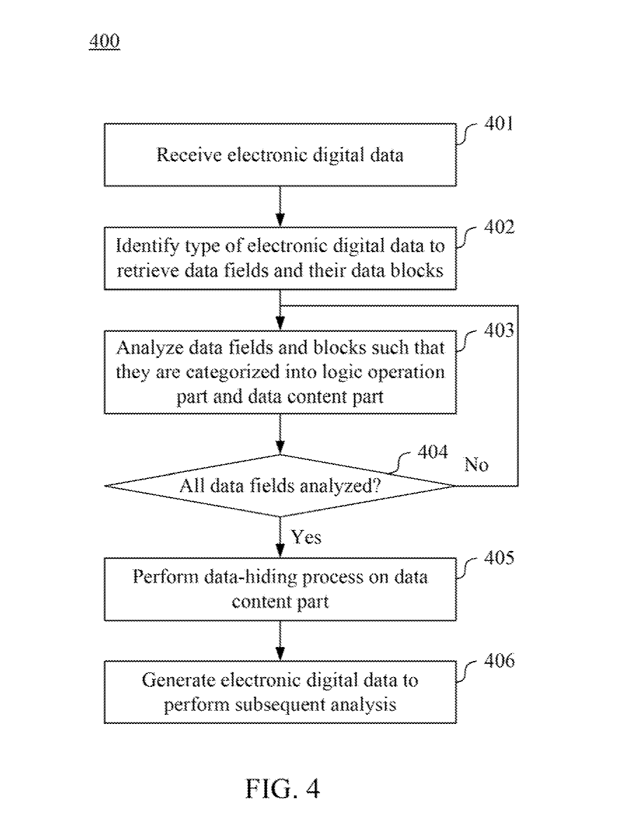

FIG. 4 is a flow chart of a method 400 for performing anonymous testing on electronic digital data in an embodiment of the present invention. The method 400 can be used in the device 1 depicted in FIG. 1. More specifically, the method for performing anonymous testing on electronic digital data is implemented by using a computer program to control the modules in the device 1. The computer program can be stored in a non-transitory computer readable medium such as a ROM (read-only memory), a flash memory, a floppy disc, a hard disc, an optical disc, a flash disc, a tape, an database accessible from a network, or any storage medium with the same functionality that can be contemplated by persons of ordinary skill in the art to which this invention pertains.

The method 400 comprises the steps outlined below, (The steps are not recited in the sequence in which the steps are performed. That is, unless the sequence of the steps is expressly indicated, the sequence of the steps is interchangeable, and all or part of the steps may be simultaneously, partially simultaneously, or sequentially performed).

In step 401, the receiving module 100 receives electronic digital data 101.

In step 402, the type identification module 102 identifies a type of the electronic digital data 101 to retrieve a plurality of data fields 103 according to the type of the electronic digital data 101, in which the data fields 103 further comprises a plurality of data blocks.

In step 403, the field-analyzing module 104 analyzes the data fields 103 and the data blocks by acquiring the field database 106 such that the data fields 103 and the data blocks are categorized as at least one logic operation part 105 and at least one data content part 107.

In step 404, the field-analyzing module 104 determines whether all of the data fields 103 are analyzed. When the analysis is not finished, the flow goes back to step 403 to perform the analysis.

When all of the data fields 103 are analyzed, in step 405, the data-hiding module 108 performs a data-hiding process on the data content part 107 only to generate at least one output electronic digital data 109 such that a subsequent analysis is performed on the output electronic digital data 109 in step 406.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A method for performing anonymous testing on electronic digital data, comprising:
receiving at least one electronic digital data;
identifying a type of the electronic digital data to retrieve a plurality of data fields according to the type of the electronic digital data, in which the data fields further comprises a plurality of data blocks;
analyzing the data fields and the data blocks such that the data fields and the data blocks are categorized as at least one logic operation part and at least one data content part; and
performing a data-hiding process on the data content part only to generate at least one output electronic digital data and performing a subsequent analysis on the output electronic digital data.

2. The method of claim 1, wherein the step of analyzing the data fields and the data blocks further comprises acquiring a field database according to the data fields and the data blocks.

3. The method of claim 1, wherein the type of the electronic digital data is a document type and the logic operation part comprises a header field, a data structure setting field, a user summary information field, a data summary information field or a combination of the above.

4. The method of claim 1, wherein the type of the electronic digital data is an image type and the logic operation part comprises a header field, a tag field or a combination of the above.

5. The method of claim 1, wherein the subsequent analysis is a vulnerability scanning process.

6. The method of claim 1, wherein the data-hiding process is an encryption process, a noise addition process, a data masking process, a random sequence generation process or a removing process.

7. A device for performing anonymous testing on electronic digital data, comprising:
a receiving module for receiving at least one electronic digital data;
a type identification module for identifying a type of the electronic digital data to retrieve a plurality of data fields according to the type of the electronic digital data, in which the data fields further comprises a plurality of data blocks;
a field-analyzing module for analyzing the data fields and the data blocks such that the data fields and the data blocks are categorized as at least one logic operation part and at least one data content part; and
a data-hiding module for performing a data-hiding process on the data content part only to generate at least one output electronic digital data such that and performing a subsequent analysis on the output electronic digital data.

8. The device of claim 7, further comprising a field database, the field-analyzing module analyzes the data fields and the data blocks by acquiring the field database according to the data fields and the data blocks.

9. The device of claim 7, wherein the type of the electronic digital data is a document type and the logic operation part comprises a header field, a data structure setting field, a user summary information field, a data summary information field or a combination of the above.

10. The device of claim 7, wherein the type of the electronic digital data is an image type and the logic operation part comprises a header field, a tag field or a combination of the above.

11. The device of claim 7, wherein the data-hiding module further transmits the output electronic digital data to an external scanning module to perform a vulnerability scanning process on the output electronic digital data.

12. The device of claim 7, wherein the device is disposed in a host or in a gateway.

13. The device of claim 7, wherein the data-hiding process is an encryption process, a noise addition process, a data masking process, a random sequence generation process or a removing process.

14. A non-transitory computer readable storage medium to store a computer program to execute method for performing anonymous testing on electronic digital data, wherein the method comprises:
receiving at least one electronic digital data;
identifying a type of the electronic digital data to retrieve a plurality of data fields according to the type of the electronic digital data, in which the data fields further comprises a plurality of data blocks;
analyzing the data fields and the data blocks such that the data fields and the data blocks are categorized as at least one logic operation part and at least one data content part; and
performing a data-hiding process on the data content part only to generate at least one output electronic digital data and performing a subsequent analysis on the output electronic digital data.

15. The non-transitory computer readable storage medium of claim 14, wherein the step of analyzing the data fields and the data blocks further comprises acquiring a field database according to the data fields and the data blocks.

16. The non-transitory computer readable storage medium of claim 14, wherein the type of the electronic digital data is a document type and the logic operation part comprises a header field, a data structure setting field, a user summary information field, a data summary information field or a combination of the above.

17. The non-transitory computer readable storage medium of claim 14, wherein the type of the electronic digital data is an image type and the logic operation part comprises a header field, a tag field or a combination of the above.

18. The non-transitory computer readable storage medium of claim 14, wherein the subsequent analysis is a vulnerability scanning process.

19. The non-transitory computer readable storage medium of claim 14, wherein the data-hiding process is an encryption process, a noise addition process, a data masking process, a random sequence generation process or a removing process.
